(19) United States
(12) Patent Application Publication
(10) Pub. No.: US 2014/0116854 A1
(43) Pub. Date: May 1, 2014

(54) CURRENCY TRANSMISSION APPARATUS

(71) Applicants: HON HAI PRECISION INDUSTRY CO., LTD., New Taipei (TW); HONG FU JIN PRECISION INDUSTRY (ShenZhen) CO.,LTD., Shenzhen (CN)

(72) Inventors: CHIH-KUN SHIH, Santa Clara, CA (US); WAN-CHENG LUO, Shenzhen (CN); XIAO-MAO XIE, Shenzhen (CN); WEI XU, Shenzhen (CN); SI-HE HU, Shenzhen (CN); YONG-GUI PAN, Shenzhen (CN)

(21) Appl. No.: 13/930,207

(22) Filed: Jun. 28, 2013

(30) Foreign Application Priority Data
Oct. 30, 2012 (CN) 2012104233270

(51) Int. Cl. B65G 13/02

(52) U.S. Cl. CPC B65G 13/02
USPC 198/780

(57) ABSTRACT

A currency transmission apparatus includes a driving roller, a supporting member, an acting member, a pressing roller, and a torsional spring. The driving roller transmits currency. The acting member is rotatably coupled to the supporting member. The pressing roller is mounted to the acting member. The torsional spring produces a torsional force to drive the acting member to rotate about the supporting member until the pressing roller contacts the driving roller. The pressing roller exerts a frictional force to the currency transmitted by the driving roller.

### REFERENCE TO RELATED APPLICATIONS

This application claims all benefits accruing under 35 U.S.C. §119 from China Patent Application No. 201210423327.0 filed on Oct. 30, 2012 in the State Intellectual Property Office of China, the contents of the China Application are hereby incorporated by reference.

### BACKGROUND

1. Technical Field

The present disclosure generally relates to currency counting machines, and particularly relates to currency transmission apparatuses used in currency counters.

2. Description of Related Art

Vending machines have been in common use for dispensing items such as snacks, beverages, alcohol, cigarettes, lottery tickets, cologne, consumer products and even gold and gems to customers automatically, after the customers insert currency or credit into the machines. A vending machine typically includes a currency counter for counting the currency deposited by customers. However, the currency often gets stuck while being transmitted in the currency counter.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a currency transmission apparatus used in a currency counter.

FIG. 2 is a partially assembled view of the currency transmission apparatus of FIG. 1.

FIG. 3 is an assembled view of the currency transmission apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

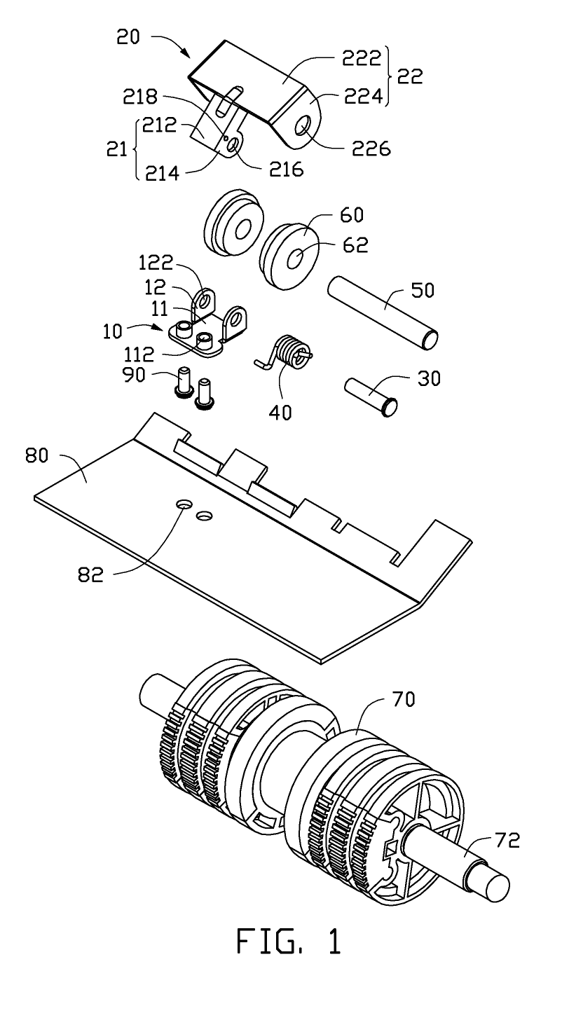

FIG. 1 shows an embodiment of a currency transmission apparatus used in a currency counter. The currency transmission apparatus includes a supporting member 10, an acting member 20, a pivotal shaft 30, a torsional spring 40, a spindle 50, two pressing rollers 60, two driving rollers 70, and a base plate 80.

The supporting member 10 includes a bottom plate 11 and two side plates 12. The two side plates 12 extend from two opposites sides of the bottom plate 11. The two side plates 12 are substantially parallel to each other and are perpendicular to the bottom plate 11. The bottom plate 11 defines two threaded holes 112. Each of the side plates 12 defines a receiving hole 122. The base plate 80 defines two securing holes 82 corresponding to the two threaded holes 112 of the bottom plate 11.

The acting member 20 includes a connecting portion 21 and a holding portion 22. The connecting portion 21 includes a connecting plate 212 and two connecting ears 214. The two connecting ears 214 extend from two opposite sides of the connecting plate 212. The two connecting ears 214 are substantially parallel to each other and are perpendicular to the connecting plate 212. Each of the two connecting ears 214 defines a pivotal hole 216. One of the two connecting ears 214 defines a through hole 218. The holding portion 22 includes a holding plate 222 and two holding ears 224. The holding plate 222 is obliquely connected to the connecting plate 212. The two holding ears 224 extend from two opposite sides of the holding plate 222. The two holding ears 224 are substantially parallel to each other and perpendicular to the holding plate 222. Each of the two holding ears 224 defines a mounting hole 226.

Each of the two pressing rollers 60 defines an aperture 62. The two driving rollers 70 are mounted to a transmission shaft 72. The transmission shaft 72 can be connected to a motor (not shown) and driven by the motor.

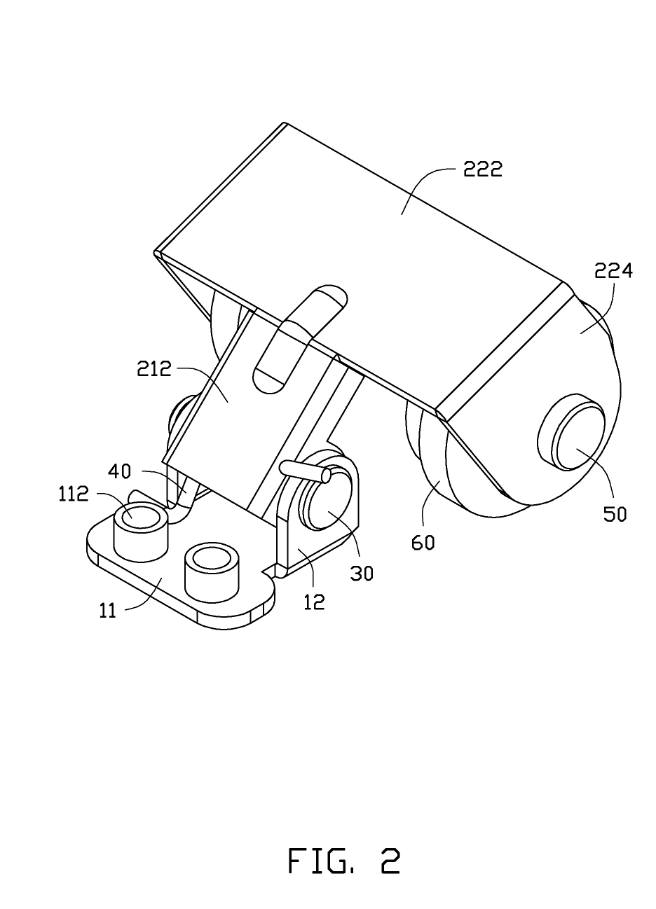

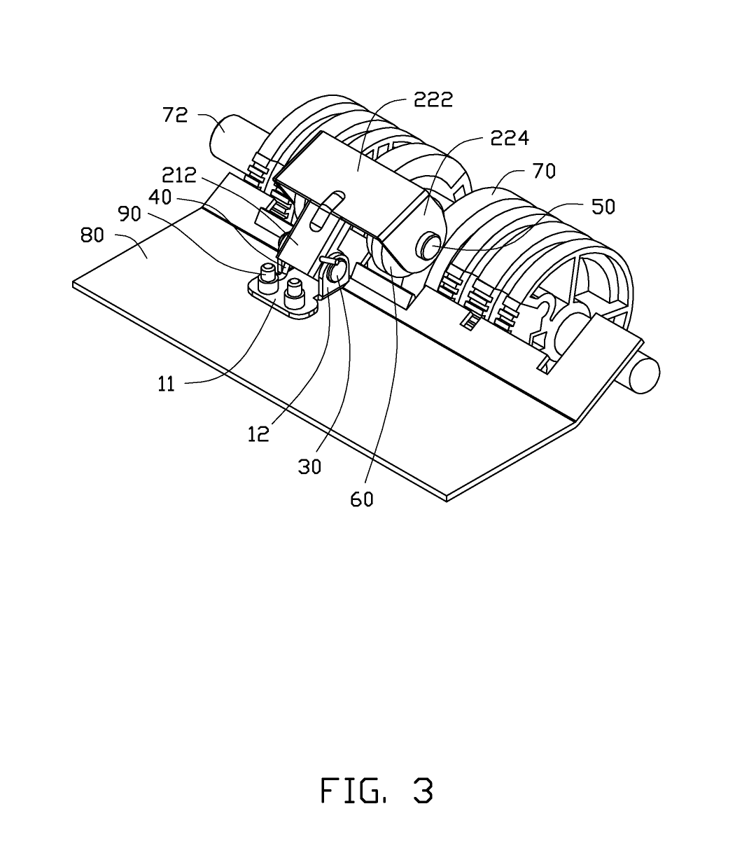

Referring to FIGS. 2 and 3, in assembly, the connecting portion 21 of the acting member 20 is located between the two side plates 12 of the supporting member 10. The two pivotal holes 216 of the connecting portion 21 are aligned with the two receiving holes 122 of the two side plates 12. The torsional spring 40 is located between the two side plates 12 of the supporting member 10. Two openings of the torsional spring 40 are aligned with the two receiving holes of the two side plate 12. The pivotal shaft 30 are successively inserted into one of the two receiving holes 122, one of the two pivotal holes 216, the torsional spring 40, the other of the two pivotal holes 216, and the other one of the two receiving holes 122. The pivotal shaft 30 is received in both the two receiving holes 122 of the supporting member 10 and the two pivotal holes 216 of the acting member 20. Thus, the acting member 20 is rotatably mounted to the supporting member 10 and can rotate about the pivotal shaft 30.

The torsional spring 40 surrounds the pivotal shaft 30. One leg of the torsional spring 40 abuts against the bottom plate 11 and another leg of the torsional spring 40 is inserted into the through hole 218 of the acting member 20. The torsional spring 40 produces a torsional force to drive the acting member 20 to rotate clockwise about the pivotal shaft 30.

The two pressing rollers 60 are located between the two holding ears 224 of the acting member 20. The apertures 62 of the two pressing rollers 60 are aligned with the two mounting holes 226 of the two holding ears 224. The spindle 50 is successively inserted into one of the two mounting holes 226, the aperture 62 of one of the two pressing rollers 60, the aperture 62 of the other of the two pressing rollers 60, and the other of the two mounting holes 226. Thus, the spindle 50 is received in the two mounting holes 226 of the acting member 20. The two pressing rollers 60 are mounted to the spindle 50. The spindle 50 is substantially parallel to the holding plate 222 of the acting member 20.

The supporting member 10 is located on the base plate 80. The two threaded holes 112 of the supporting member 10 are aligned with the two securing holes 82 of the base plate 80. A bolt 90 is successively inserted into one of the two securing holes 82 and one of the two threaded holes 112. Thus, the supporting member 10 is mounted to the base plate 80.

The two driving rollers 70 are located at one side of the base plate 80. The torsional spring 40 produces a torsional force to drive the acting member 20 to rotate towards the two driving rollers 70 until the two pressing rollers 60 press the two driving rollers 70. While the two driving rollers 70 are actuated to rotate about the transmission shaft 72, the two pressing rollers 60 exert frictional forces to the currency transmitted by the two driving rollers 70.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A currency transmission apparatus comprising:
a driving roller for transmitting currency;
a supporting member;
an acting member rotatably coupled to the supporting member via a pivotal shaft;
a pressing roller mounted to the acting member; and
a torsional spring surrounding the pivotal shaft, wherein the torsional spring comprises a first leg abutting the supporting member and a second leg connected to the acting member, the torsional spring is adapted to exert a torsional force to drive the acting member to rotate towards the driving roller and drive the pressing roller to exert a frictional force to the currency transmitted by the driving roller.

2. The currency transmission apparatus of claim 1, wherein the supporting member comprises a bottom plate and two side plates extending from two opposite sides of the bottom plate.

3. The currency transmission apparatus of claim 2, wherein the acting member comprises a connecting portion and a holding portion extending from the connecting portion, the connecting portion is rotatably mounted to the two side plates, the pressing roller is mounted to the holding portion.

4. The currency transmission apparatus of claim 3, wherein the connecting portion comprises a connecting plate and two connecting ears extending from two opposite sides of the connecting plate.

5. The currency transmission apparatus of claim 4, wherein each of the two side plates defines a receiving hole, each of the two connecting ears defines a pivotal hole, the pivotal shaft is inserted into the receiving hole of each of the two side plates and the pivotal hole of each of the two connecting ears thereby rotatably mounting the acting member to the supporting member.

6. The currency transmission apparatus of claim 5, wherein the torsional spring is located between the two side plates of the supporting member.

7. The currency transmission apparatus of claim 5, wherein one of the two connecting ears defines a through hole, the second leg of the torsional spring is inserted into the through hole.

8. The currency transmission apparatus of claim 4, wherein the holding portion comprises a holding plate and two holding ears extending from two opposite sides of the holding plate, the holding plate is obliquely connected to the connecting plate.

9. The currency transmission apparatus of claim 8, further comprising a spindle, wherein each the two holding ears defines a mounting hole, the pressing roller defines an aperture, the spindle is inserted into the mounting hole of each of the two holding ears and the aperture of the pressing roller thereby mounting the pressing roller to the acting member.

10. The currency transmission apparatus of claim 2, further comprising a base plate defining a securing hole, wherein the bottom plate defines a threaded hole, a bolt is inserted the securing hole and the threaded hole thereby mounting the supporting member to the base plate.

11. A currency transmission apparatus comprising:
a driving roller connected to a transmission shaft and adapted to transmit currency;
a supporting member;
an acting member rotatably coupled to the supporting member;
a pressing roller mounted to the acting member; and
a torsional spring comprising a first leg abutting the supporting member and a second leg connected to the acting member, wherein the torsional spring is adapted to exert a torsional force to drive the acting member to rotate towards the driving roller and drive the pressing roller to exert a frictional force to the currency transmitted by the driving roller.

12. The currency transmission apparatus of claim 11, wherein the supporting member comprises a bottom plate and two side plates extending from two opposite sides of the bottom plate.

13. The currency transmission apparatus of claim 12, wherein the acting member comprises a connecting portion and a holding portion extending from the connecting portion, the connecting portion is rotatably mounted to the two side plates, the pressing roller is mounted to the holding portion.

14. The currency transmission apparatus of claim 13, wherein the connecting portion comprises a connecting plate and two connecting ears extending from two opposite sides of the connecting plate.

15. The currency transmission apparatus of claim 14, further comprising a pivotal shaft, wherein each of the two side plates defines a receiving hole, each of the two connecting ears defines a pivotal hole, the pivotal shaft is inserted into the receiving hole of each of the two side plates and the pivotal hole of each of the two connecting ears thereby rotatably mounting the acting member to the supporting member.

16. The currency transmission apparatus of claim 15, wherein the torsional spring surrounds the pivotal shaft, the torsional spring comprises a first leg abutting the bottom plate and a second leg connected to the acting member.

17. The currency transmission apparatus of claim 16, wherein one of the two connecting ears defines a through hole, the second leg of the torsional spring is inserted into the through hole.

18. The currency transmission apparatus of claim 14, wherein the holding portion comprises a holding plate and two holding ears extending from two opposite sides of the holding plate, the holding plate is obliquely connected to the connecting plate.

19. The currency transmission apparatus of claim 18, further comprising a spindle, wherein each the two holding ears defines a mounting hole, the pressing roller defines an aperture, the spindle is inserted into the mounting hole of each of the two holding ears and the aperture of the pressing roller thereby mounting the pressing roller to the acting member.

20. The currency transmission apparatus of claim 12, further comprising a base plate defining a securing hole, wherein the bottom plate defines a threaded hole, a bolt is inserted the securing hole and the threaded hole thereby mounting the supporting member to the base plate.
